(19) United States
(12) Patent Application Publication
(10) Pub. No.: US 2008/0055520 A1
(43) Pub. Date: Mar. 6, 2008

(54) LIQUID CRYSTAL DISPLAY MODULE

(75) Inventors: Chih-Kuo Chuang, Hsinchu (TW); Wei-Lung Huang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CORETRONIC CORPORATION, Hsinchu (TW)

(21) Appl. No.: 11/770,744

(22) Filed: Jun. 29, 2007

(30) Foreign Application Priority Data
Aug. 29, 2006 (TW) 95131705

(51) Int. Cl. G02F 1/133

(52) U.S. Cl. 349/73

(57) ABSTRACT

An LCD module including a plurality of LCD panels arranged in an array and a backlight unit is provided. Each of the LCD panels has a display area and a non-display area surrounding the display area, and the non-display area of each LCD panel is overlapped with the non-display areas of the adjacent LCD panels. The backlight unit is disposed under the LCD panels.

### CROSS-REFERENCE TO RELATED APPLICATION

This application claims the priority benefit of Taiwan application serial no. 95131705, filed Aug. 29, 2006. All disclosure of the Taiwan application is incorporated herein by reference.

### BACKGROUND OF THE INVENTION

1. Field of the Invention

The present invention generally relates to a liquid crystal display module (LCD module). More particularly, the present invention relates to an LCD module comprising a plurality of liquid crystal display panels (LCD panels).

2. Description of Related Art

Due to the restriction of manufacturing equipments, fabrication of large-size LCD panels still faces many bottlenecks. In addition, in order to control the cost and the production yield, an LCD panel is usually cut to have an appropriate dimension during the fabrication process thereof. Therefore, to make an LCD apparatus capable of providing a larger display image, the common preferred scheme today is to assemble a plurality of LCD panels arranged in an array together to form a required LCD apparatus.

FIG. 1A is a perspective view of a conventional LCD module, while FIG. 1B is a cross-sectional view along plane I-I in FIG. 1A. Referring to FIGS. 1A and 1B, a conventional LCD module 100 includes two LCD panels 110 and a backlight unit 120. The LCD panel 110 has a display area 112 and a non-display area 114 surrounding the display area 112. The two LCD panels 110 are connected to each other, so as to enable the LCD module 100 to provide a larger display image.

As shown in FIG. 1A, the width of the non-display area 114 is w₁, while the gap between the two display areas 112 is d₁. Herein, since the two LCD panels 110 are connected to each other, the gap d₁ would be equal to a double of the widths w₁ of the non-display area 114, which makes the whole display image of the LCD module 100 appear in bad continuity.

### SUMMARY OF THE INVENTION

Accordingly, the present invention is directed to provide an LCD module, so as to make the whole display image have better continuity.

As embodied and described broadly herein, the present invention provides an LCD module, which includes a plurality of LCD panels arranged in an array and at least a backlight unit. Each of the LCD panels has a display area and a non-display area surrounding the display area, and the non-display area of each the LCD panel is overlapped with the non-display areas of the adjacent LCD panels. The backlight unit is disposed under the LCD panels.

According to an embodiment of the present invention, the above-mentioned LCD panels include transmissive LCD panels or transflective LCD panels.

In an embodiment of the present invention, the above-mentioned LCD panel is arranged in an (M×N) array, wherein M is a positive integer greater than or equal to 1 and N is a positive integer greater than 1.

In an embodiment of the present invention, the above-mentioned backlight unit is a direct-type backlight unit.

In an embodiment of the present invention, the above-mentioned direct-type backlight unit includes a light chassis, at least a light source, at least an optical film and a plurality of first spacers. The light source is disposed inside the light chassis, while the optical film is disposed over the light source. The first spacers are disposed between the optical film and the light chassis.

In an embodiment of the present invention, the above-mentioned direct-type backlight unit further includes at least a second spacer, which is disposed between the LCD panels and the light chassis.

In an embodiment of the present invention, the above-mentioned second spacer is located under the overlapped non-display areas of the LCD panels.

In an embodiment of the present invention, the above-mentioned second spacer has an LCD panel-supporting surface and a plurality of optical film-supporting surfaces, and the optical film-supporting surfaces are lower than the LCD panel-supporting surface.

In an embodiment of the present invention, the above-mentioned optical film includes a diffuser, a brightness enhancement film (BEF), a prism film or combinations thereof.

In an embodiment of the present invention, the above-mentioned backlight unit is an edge-type backlight unit.

In an embodiment of the present invention, the above-mentioned LCD module further includes a bezel, which is used to fix the LCD panels onto the backlight unit.

Since the LCD panels of the present invention are arranged in an array by overlapping the adjacent non-display areas with each other, therefore, the overall non-display area between the adjacent two LCD panels can be reduced, which makes the whole display image have better continuity.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a perspective view of a conventional LCD module.

FIG. 1B is a cross-sectional view along plane I-I in FIG. 1A.

FIG. 2A is a perspective view of an LCD module according to an embodiment of the present invention.

FIG. 2B is a cross-sectional view along plane II-II in FIG. 2A.

FIG. 3 is a perspective view of an LCD module according to another embodiment of the present invention.

### DESCRIPTION OF THE EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “under,” “over,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Similarly, the terms “overlap,” “overlapped” and variations thereof herein are used broadly and encompass direct and indirect overlapped. Therefore, the description of “A” component is overlapped with “B” component herein may contain the situations that “A” component is overlapped with “B” component directly or one or more additional components is between “A” component and “B” component. Accordingly, the drawings and descriptions will be regarded as illustrative in nature and not as restrictive.

Reference will now be made in detail to the present preferred embodiments of the invention, examples of which are illustrated in the accompanying drawings. Wherever possible, the same reference numbers are used in the drawings and the description to refer to the same or like parts.

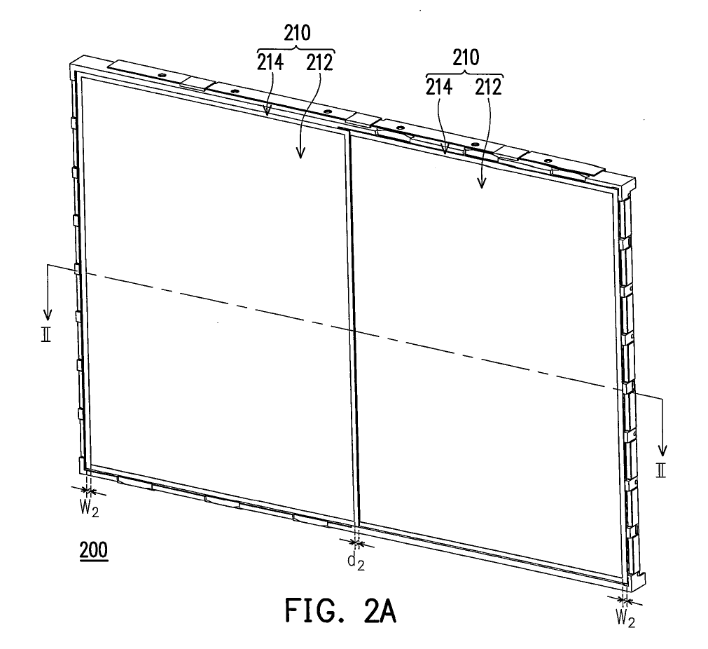

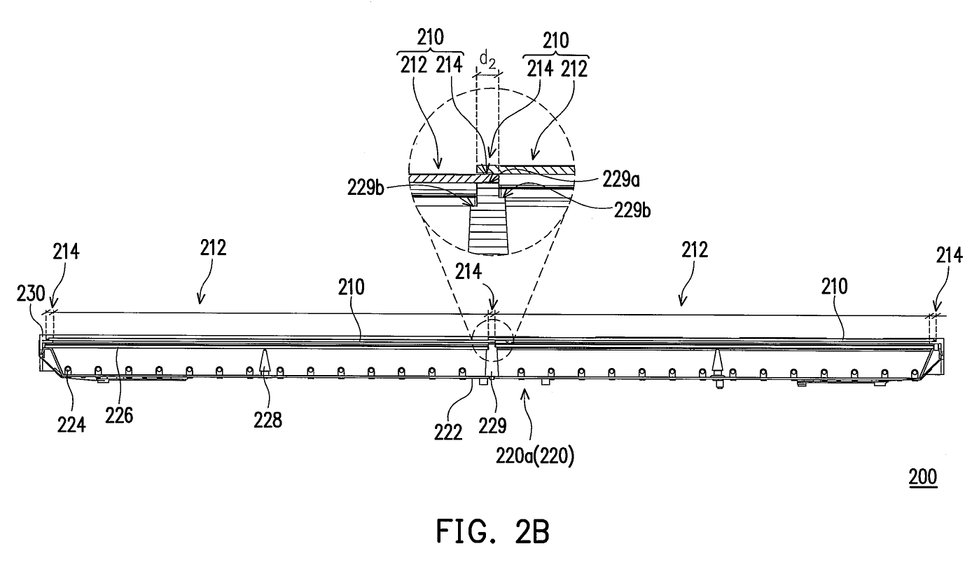

FIG. 2A is a perspective view of an LCD module according to an embodiment of the present invention, while FIG. 2B is a cross-sectional view along plane II-II in FIG. 2A. Referring to FIGS. 2A and 2B, an LCD module 200 includes a plurality of LCD panels 210 and at least a backlight unit 220. In the embodiment, an LCD module 200 including two LCD panels 210 and a backlight unit 220 is described as an example. The LCD panels 210 are arranged in an array. Specifically, in the embodiment, the quantity of the LCD panels 210 is, for example, two and the LCD panels 210 are arranged, for example, in an (1×2) array. In addition, the LCD panels 210 are, for example, transmissive LCD panels or transflective LCD panels, while the backlight unit 220 is, for example, a direct-type backlight unit 220a.

Each of the LCD panels 210 has a display area 212 and a non-display area 214 surrounding the display area 212. The non-display area 214 at the right side edge of the left-side LCD panel 210 is overlapped with the non-display area 214 at the left side edge of the right-side LCD panel 210. Additionally, the backlight unit 220 is disposed under the two LCD panels 210.

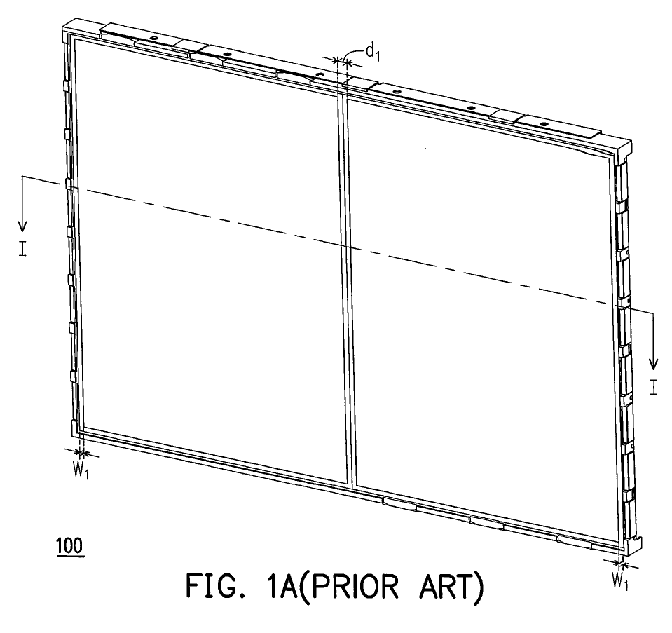

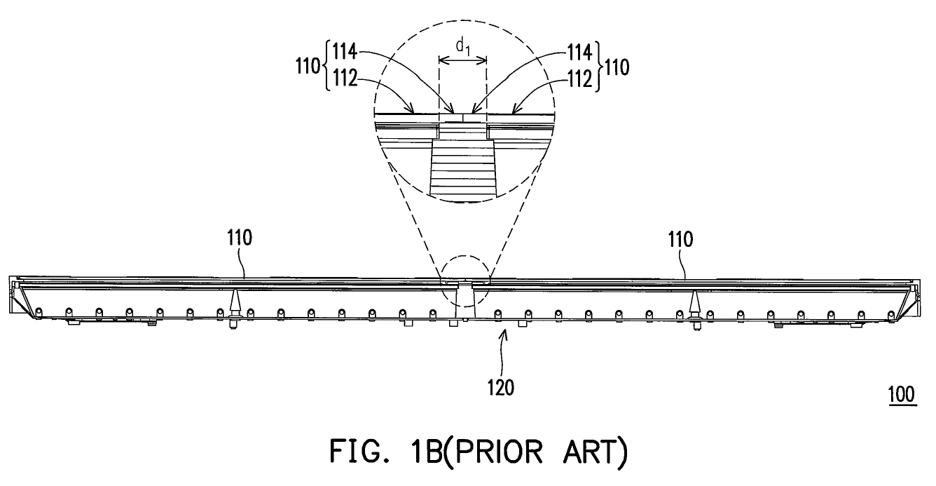

As shown in FIG. 2A, the width of the non-display area 214 is w₂, while the gap between the two display areas 212 is d₂. When the non-display area 214 at the right side edge of the left-side LCD panel 210 is overlapped with the non-display area 214 at the left side edge of the right-side LCD panel 210, the gap d₂ would be less than the double of the widths w₂ of the non-display area 214. Thus, in comparison with the conventional LCD module 100 (shown in FIG. 1), the whole display image of the LCD module 200 of the present invention has a better continuity.

In the embodiment, the non-display area 214 at the right side edge of the left-side LCD panel 210 is almost completely overlapped with the non-display area 214 at the left side edge of the right-side LCD panel 210 (as shown by FIG. 2B), therefore, the gap d₂ would be equal to the width w₂ of the non-display area 214. As a result, the gap d₂ herein is minimized, which accordingly has the best image continuity.

Referring to FIG. 2B, the direct-type backlight unit 220a according to the embodiment includes a light chassis 222, at least a light source 224, at least an optical film 226, a plurality of first spacers 228 and at least a second spacer 229. The light source 224 is disposed inside the light chassis 222, while the optical film 226 is disposed over the light chassis 222. The optical film 226 is, for example, a diffuser, a BEF, a prism film or combinations thereof.

The first spacers 228 are disposed between the optical film 226 and the light chassis 224 so as to sustain the optical film 226; the second spacer 229 is disposed between the LCD panels 210 and the light chassis 222 and is located under the overlapped non-display areas 214 of the LCD panels 210 so as to sustain the LCD panels 210. The second spacer 229 has an LCD panel-supporting surface 229a and a plurality of optical film-supporting surfaces 229b, and the optical film-supporting surfaces 229b are lower than the LCD panel-supporting surface 229a. The LCD panel-supporting surface 229a is located under the overlapped non-display areas 214 of the LCD panels 210 to support the overlapped non-display areas 214, while the optical film-supporting surfaces 229b are located under the display areas to support the LCD panels 210. Therefore, the second spacer 229 is used to support not only the LCD panels 210, but also the optical films 226, so as to avoid the LCD panels 210 and the optical films 226 from being bent resulted from there is not insufficient support at the edge of the LCD panels 210 and the optical films 226. Besides, the LCD module 200 can further include a bezel 230 for fixing the LCD panels 210 onto the backlight unit 220.

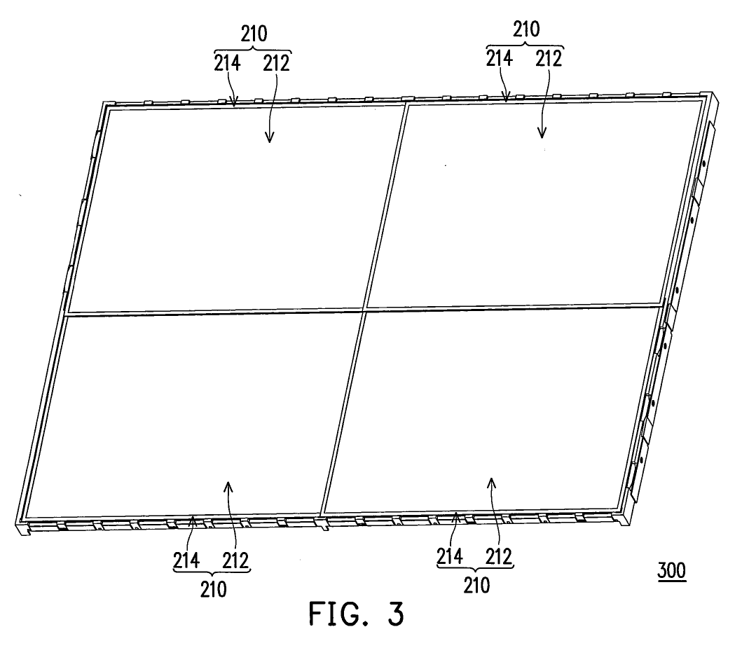

FIG. 3 is a perspective view of an LCD module according to another embodiment of the present invention. Referring to FIG. 3, an LCD module 300 has the similar structure to the LCD module 200 in FIG. 2A except for the quantity of the LCD panels 210. In the embodiment, the quantity of the LCD panels 210 is four, and the LCD panels 210 are arranged in a (2×2) array. Since the non-display areas 214 of the LCD panels 210 are overlapped with the non-display areas 214 of the adjacent LCD panels 210, therefore, in comparison with the conventional LCD module 100, the whole display image of the LCD module 300 in the present embodiment has better continuity.

It is noted that, the quantity of the LCD panels 210 is not limited to the quantity provided by the above-mentioned embodiments. In fact, the real quantity can be a number other than the above-mentioned quantity, and the LCD panels 210 can be arranged in other arrays as well. In other words, the LCD panels 210 can be arranged in an (M×N) array, wherein M is a positive integer greater than or equal to 1 and N is a positive integer greater than 1. In addition, the backlight unit 220 is not limited to the direct-type backlight unit 220a and the backlight unit 220 can be an edge-type backlight unit as well.

In summary, since the LCD panels of the present invention are arranged in an array by overlapping the adjacent non-display areas with each other, therefore, the overall non-display area between the adjacent two LCD panels can be reduced, which makes the whole display image have better continuity. In addition, the second spacer is disposed under the overlapped non-display areas and used to support the LCD panels and the optical films, thus, the distortions thereof resulted from the insufficient support at the edge of the LCD panels and the optical films can be avoided effectively.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An LCD module, comprising:
a plurality of LCD panels arranged in an array, wherein each of said LCD panels has a display area and a non-display area surrounding said display area, and said non-display area of each said LCD panel is overlapped with said non-display areas of said adjacent LCD panels; and
at least a backlight unit, disposed under said LCD panels.

2. The LCD module according to claim 1, wherein said LCD panels comprise transmissive LCD panels or transflective LCD panels.

3. The LCD module according to claim 1, wherein said LCD panels are arranged in an (M×N) array, M is a positive integer greater than or equal to 1 and N is a positive integer greater than 1.

4. The LCD module according to claim 1, wherein said backlight unit is a direct-type backlight unit.

5. The LCD module according to claim 4, wherein said direct-type backlight unit comprises:
a light chassis;
at least a light source, disposed inside said light chassis;
at least an optical film, disposed over said light chassis; and
a plurality of first spacers, disposed between said optical film and said light chassis.

6. The LCD module according to claim 5, wherein said direct-type backlight unit further comprises at least a second spacer disposed between said LCD panels and said light chassis.

7. The LCD module according to claim 6, wherein said second spacer is located under said overlapped non-display areas of said LCD panels.

8. The LCD module according to claim 6, wherein each of said second spacers has an LCD panel-supporting surface and a plurality of optical film-supporting surfaces, and said optical film-supporting surfaces are lower than said LCD panel-supporting surface.

9. The LCD module according to claim 5, wherein said optical film comprises a diffuser, a brightness enhancement film (BEF), a prism film or combinations thereof.

10. The LCD module according to claim 1, wherein said backlight unit is an edge-type backlight unit.

11. The LCD module according to claim 1, further comprising a bezel, wherein said bezel fixes said LCD panels onto said backlight unit.
